(19) United States
(12) Patent Application Publication
(10) Pub. No.: US 2015/0091380 A1
(43) Pub. Date: Apr. 2, 2015

(54) POWER CONVERSION DEVICE WITH MULTIPLE INTERFACES

(71) Applicant: KUANG YING COMPUTER EQUIPMENT CO., LTD., New Taipei City (TW)

(72) Inventors: CHUN-TE CHANG, New Taipei City (TW); HSUAN-HO CHUNG, New Taipei City (TW); YU-HUNG LIN, New Taipei City (TW); YI-HUNG YU, New Taipei City (TW)

(73) Assignee: KUANG YING COMPUTER EQUIPMENT CO., LTD., New Taipei City (TW)

(21) Appl. No.: 14/038,782

(22) Filed: Sep. 27, 2013

(51) Int. Cl. H02J 1/00

(52) U.S. Cl. CPC H02J 1/00
USPC 307/23

(57) ABSTRACT

A power conversion device with multiple interfaces generally includes at least one multiple-in-one connector, at least one circuit board, and a power supply module. The multiple-in-one connector and the power supply module are electrically connected to the circuit board. The power supply module satisfies the standard of an electric main socket or an automobile socket. Further, the multiple-in-one connector can be of a multiple-in-one connector that has a single plugging port and includes a USB interface combined with a card type interface or a signal connector interface or alternatively simultaneously combined with a battery module, a storage module, and a wireless transmission module to achieve an advantage of having multiple interfaces.

### TECHNICAL FIELD OF THE INVENTION

The present invention generally relates to a power conversion device, and more particularly to a power conversion device with multiple interfaces, which comprises various multiple-in-one connection sockets in combination with a mobile power supply.

### DESCRIPTION OF THE PRIOR ART

The contemporary electronic devices, particularly smart phones and tablet computers, generally need great power consumption. To handle the issue that the electrical cells might get fast used up, mobile power supplies are available in the market, which is advantageous in having a large cell capacity that is sufficient to completely charge an electronic device and being small in size for ease of carrying.

However, most of the mobile power supplies have the simple function of storage of electrical power and power output for charging and are classified just according to the capacities thereof. In the modem, fully developed societies, people often carry more than one electronic device with them and their needs associated with these electronic devices are not just charging of power. They usually desire more interfaces to be selectively used to meet their needs. At present, people need to carry a number of connectors and various types of adaptors to suit the above needs. This imposes a large burden to the users.

Thus, it is a challenge of the present inventor and the manufacturers of the industry to overcome the above discussed problems.

### SUMMARY OF THE INVENTION

In view of the above drawbacks, the present invention aims to provide a power conversion device with multiple interfaces that comprises various multiple-in-one connection sockets in combination with a mobile power supply.

The primary object of the present invention is to provide a power conversion device that comprises at least a multiple-in-one connector, a power supply module that satisfies the standard of an electric main socket or automobile socket, a battery module (serving as a mobile power supply), a storage module (serving as a portable data storage), and a wireless transmission module (serving as a relay base station) all integrated therein so as to achieve an advantage that a user is provided with multiple interfaces for operation by carrying only the power conversion device according to the present invention.

To achieve the above object, the present invention has a primary structure that comprises an electronic module and a power supply module, wherein the electronic module comprises at least one multiple-in-one connector 2 that comprises a single plugging port, at least one circuit board 3 electrically connected to the multiple-in-one connector, a battery module electrically connected to the circuit board, a storage module electrically connected to the circuit board, and a wireless transmission module in information connection with the circuit board. The power supply module can be a plug carrying a power cable or a cable-free plug according to the needs. As such, in an attempt to use a connector of a USB interface, an RJ series interface, or a memory card series interface, since the multiple-in-one connector comprises a USB interface combined with a card type interface or a signal connector interface, plugging can directly made into the multiple-in-one connector to achieve the function of information connection. Further, in an indoor space, a power supply module that satisfies the standard of an electric main socket can be used and in an automobile, a power supply module that satisfies the standard of an automobile socket can be used to electrically charge the battery module. For an attempt to achieve a use as a portable storage to store portable data, the storage module can be used. For an attempt to achieve a use as an access point or a wireless base station, the wireless transmission module can be used. It can thus be appreciated that the present invention possesses the above described advantages and improvements.

With the above-described technique, the drawbacks of the conventional mobile power supplies that have very limited functionality, only a small number of interfaces, and less uses can be overcome.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a preferred embodiment of the present invention.

FIG. 2 is a perspective view illustrating a plug connector of the present invention plugged in an indoor wall socket.

FIG. 3 is a perspective view illustrating an example of a cable-free plug of a power supply module of the present invention.

FIG. 4 is a perspective view showing another preferred embodiment of the present invention.

FIG. 5 is a perspective view illustrating another plug connector of the present invention plugged in an automobile socket.

FIG. 6 is a perspective view illustrating another example of a cable-free plug of a power supply module of the present invention.

FIG. 7 is a perspective view showing a further preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims

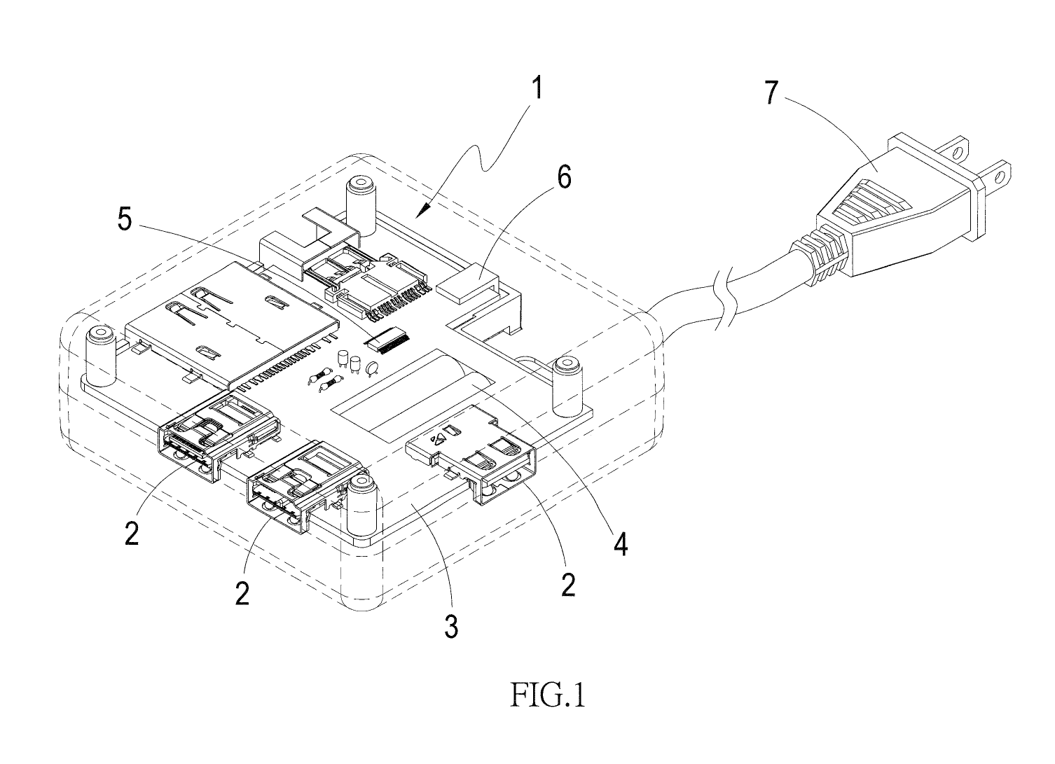

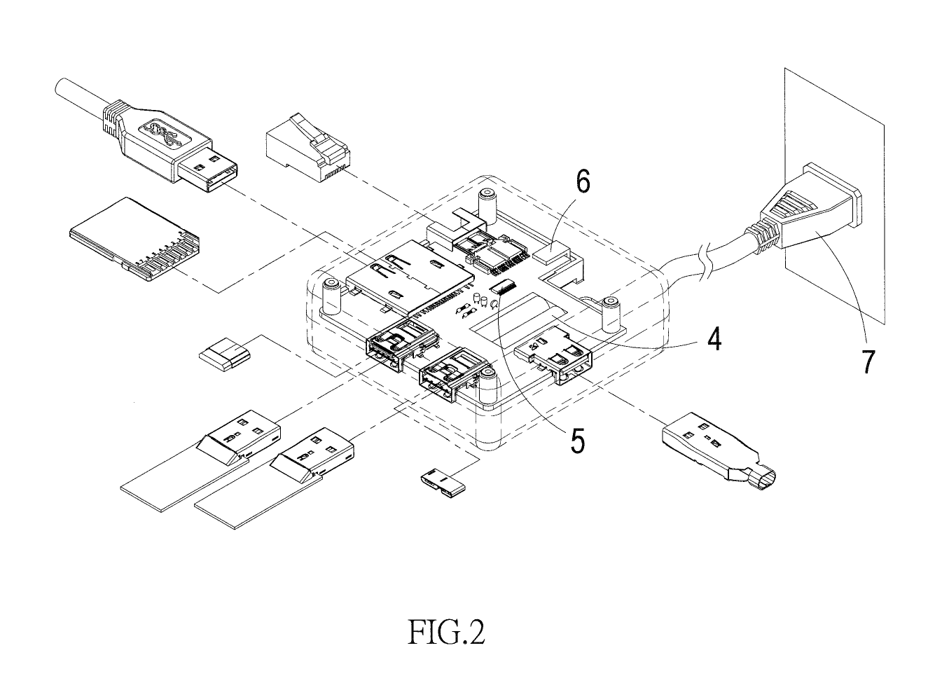

Referring to FIGS. 1 and 2, which are respectively a perspective view showing a preferred embodiment of the present invention and a perspective view illustrating a plug connector of the present invention plugged in an indoor wall socket, it can be clearly seen from these drawings that the present invention comprises the following components:

An electronic module 1 comprises at least one multiple-in-one connector 2 that comprises a single plugging port, at least one circuit board 3 electrically connected to the multiple-in-one connector 2, a battery module 4 electrically connected to the circuit board 3, a storage module 5 electrically connected to the circuit board 3, and a wireless transmission module 6 in information connection with the circuit board.

A power supply module 7 satisfies the standard of an electric main socket and is electrically connected to the circuit board 3. The power supply module 7 comprises a plug carrying a power cable.

When a user attempts to use an electronic device that comprises a connector belonging to a USB interface, an RJ series interface, and a memory card series interface, since the multiple-in-one connector 2 described in the present invention is a connector that comprises a USB interface combined with a card type interface or an RJ series interface or a memory card series interface, the user is allowed to make direct plugging into the multiple-in-one connector 2 to achieve information connection. Further, in an indoor space, due to the power supply module 7 being made to satisfy the standard of an electric main socket, for an attempt to achieve a use as a portable storage to store portable data, access can be made with the storage module 5 or for an attempt to achieve a use as an access point or a wireless base station, the wireless transmission module 6 can be used for data forwarding and sharing.

Further explanation will be given to the multiple-in-one connector 2. The multiple-in-one connector 2 can be a multiple-in-one connector 2 having a single plugging port that comprises a USB interface combined with an SD series card interface or a USB interface combined with an RJ interface or an USB interface combined with a SIM card interface.

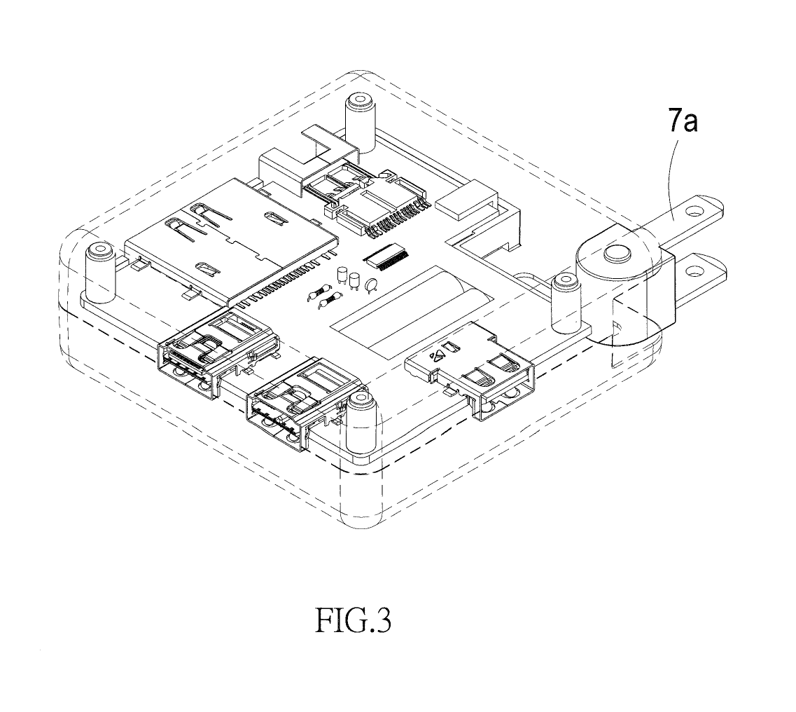

Referring to FIG. 3, which a perspective view illustrating an example of a cable-free plug of a power supply module of the present invention, the drawing clearly shows that the instant embodiment comprises a power supply module 7a that is embodied as a cable-free plug and the remaining structure is identical to what described above so that repeated description will be omitted here.

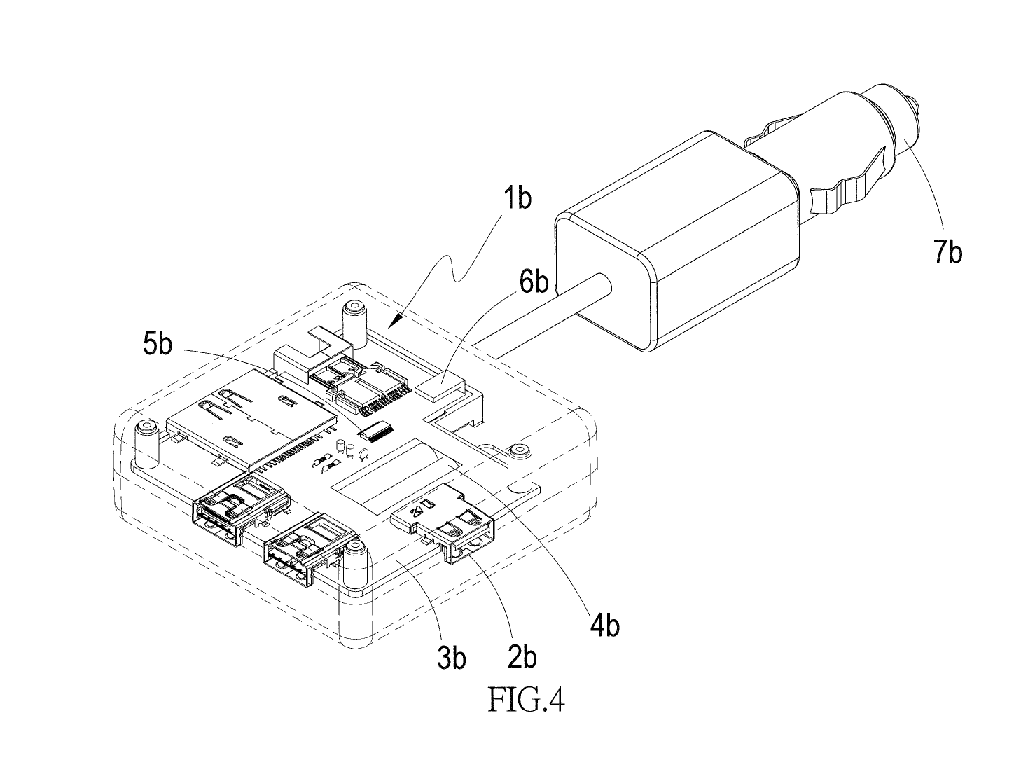

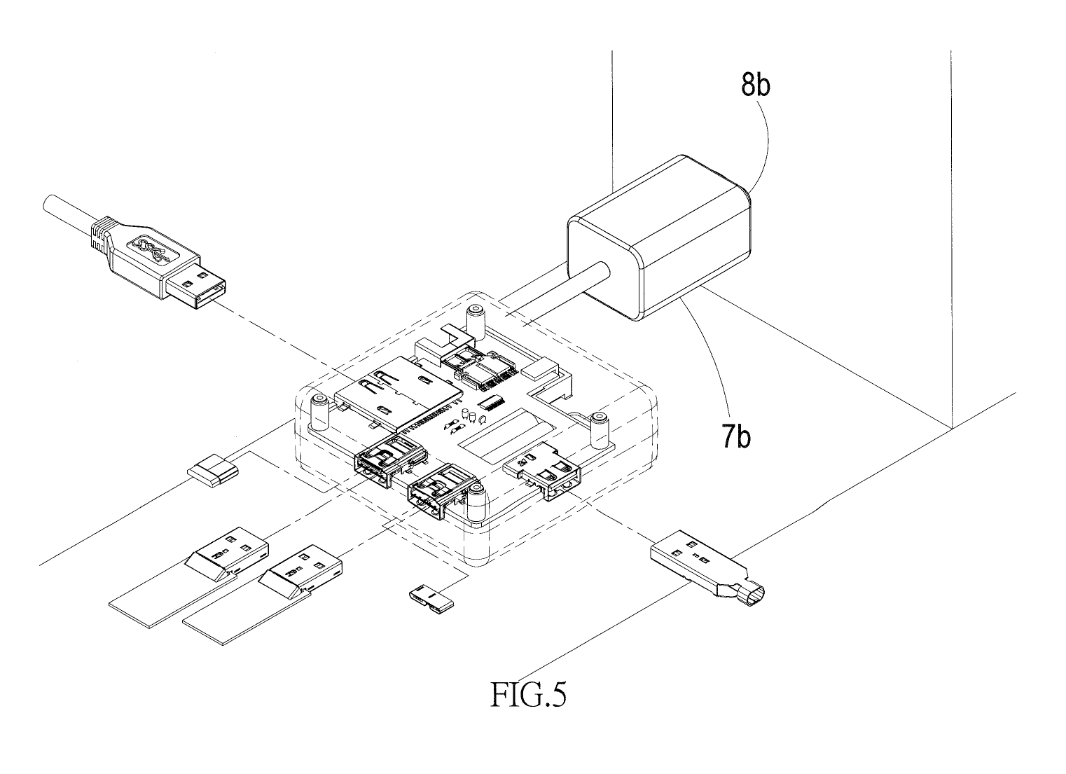

Referring to FIGS. 4 and 5, which are respectively a perspective view showing another preferred embodiment of the present invention and a perspective view illustrating another plug connector of the present invention plugged in an automobile socket, it can be clearly seen from the drawings that the present invention comprises the following components:

An electronic module lb comprises at least one multiple-in-one connector 2b that comprises a single plugging port, at least one circuit board 3b electrically connected to the multiple-in-one connector 2b, a battery module 4b electrically connected to the circuit board 3b, a storage module 5b electrically connected to the circuit board 3b, and a wireless transmission module 6b in information connection with the circuit board.

A power supply module 7b satisfies the standard of an automobile socket and is electrically connected to the circuit board 3b. The power supply module 7b comprises a plug carrying a power cable.

When a user attempts to make electrical charging to the battery module 4b, the power supply module 7b can be directly plugged into a cigarette light 8b (which is a power socket) formed in an automobile to proceed with charging to the battery module 4b. Further, it is also possible to achieve the function of sharing network through the wireless transmission module 6b.

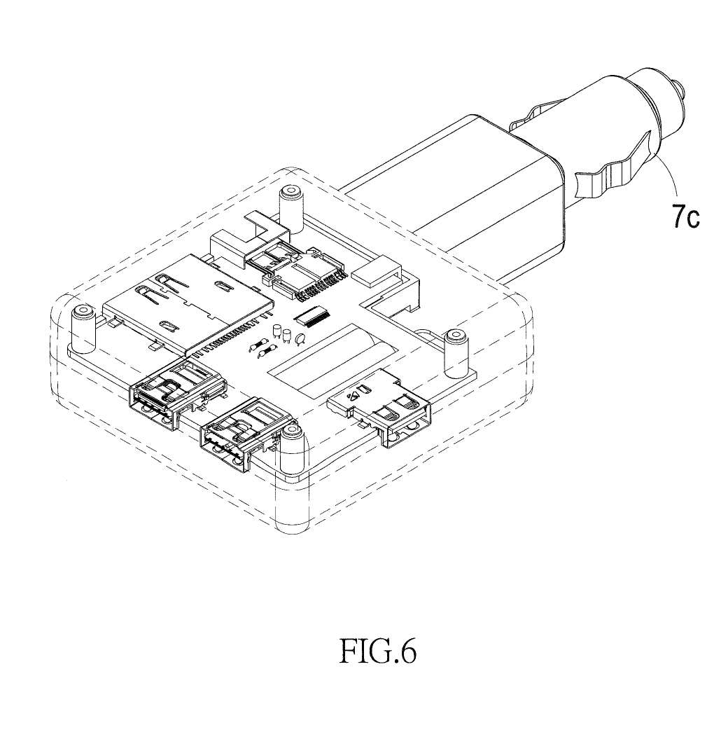

Referring to FIG. 6, which is a perspective view illustrating another example of a cable-free plug of a power supply module of the present invention, the drawing clearly shows that the instant embodiment comprises a power supply module 7c that is embodied as a cable-free plug and the remaining structure is identical to what described above so that repeated description will be omitted here.

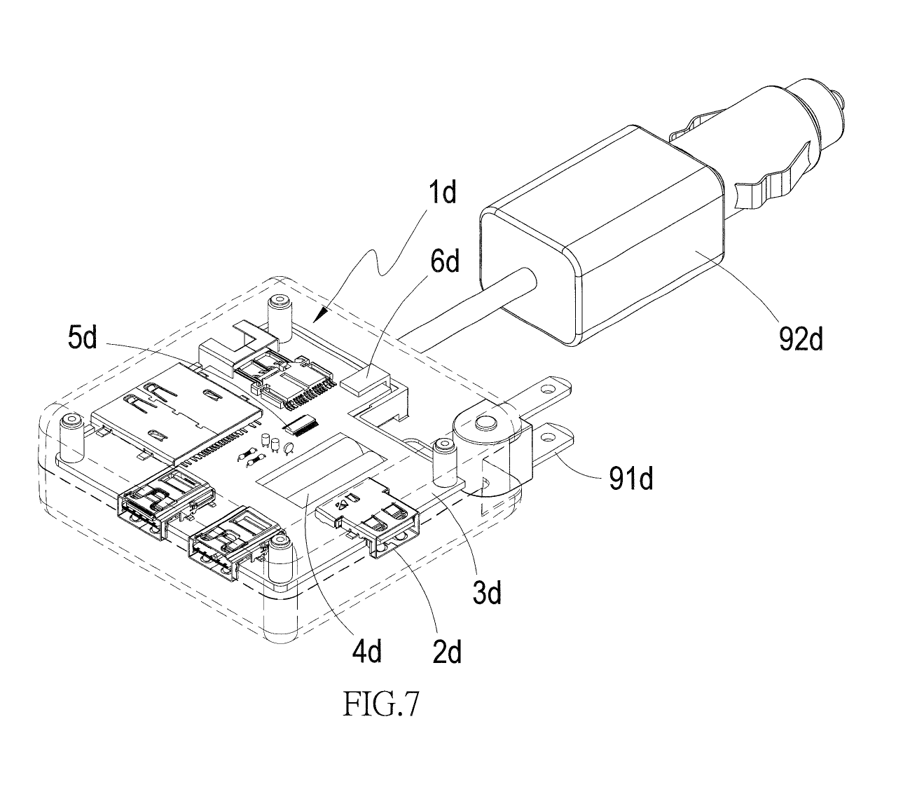

Referring to FIG. 7, which is a perspective view showing a further preferred embodiment of the present invention, it can be clearly seen from the drawing that the present invention comprises the following components:

An electronic module 1d comprises at least one multiple-in-one connector 2d that comprises a single plugging port, at least one circuit board 3d electrically connected to the multiple-in-one connector 2d, a battery module 4d electrically connected to the circuit board 3d, a storage module 5d electrically connected to the circuit board 3d, and a wireless transmission module 6d in information connection with the circuit board.

A first power supply module 91d satisfies the standard of an electric main socket and is electrically connected to the circuit board 3d.

A second power supply module 92d satisfies the standard of an automobile socket and is electrically connected to the circuit board 3d. Further, the first power supply module 91d and the second power supply module 92d are each one of a plug carrying a power cable and a cable-free plug.

When a user attempts to do electrical charging or to forward a file in an indoor space, the first power supply module 91d that satisfies the standard or an electrical main socket is used to plug into an indoor power socket to establish electrical connection thereby achieving an advantage of electrically charging the battery module 4d to subsequently serve as a mobile power supply and further, a wireless base station can be realized with the wireless transmission module 6d. Further, a use as a portable data storage can be realized with the storage module 5d. Further, the embodiment can use the second power supply module 92d to establish electrical connection with an automobile socket so as to enable electrical charging of the battery module 4d with electrical power of the automobile for subsequent use as a mobile power supply.

Thus, the key technical feature that the power conversion device with multiple interfaces according to the present invention adopts to overcome the drawbacks of the known techniques is as follows:

A power conversion device that comprises at least a multiple-in-one connector 2, a power supply module 7 that satisfies the standard of an electric main socket or automobile socket, a battery module 4 (serving as a mobile power supply), a storage module 5 (serving as a portable data storage), and a wireless transmission module 6 (serving as a relay base station) all integrated therein so as to achieve an advantage that a user is provided with multiple interfaces for operation by carrying only the power conversion device according to the present invention.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A power conversion device with multiple interfaces, comprising:
an electronic module, which comprises at least one multiple-in-one connector that comprises a single plugging port and at least one circuit board electrically connected to the multiple-in-one connector; and
a power supply module, which satisfies a standard of an electric main socket and is electrically connected to the circuit board.

2. The power conversion device with multiple interfaces according to claim 1, wherein the electronic module further comprises a battery module electrically connected to the circuit board, a storage module electrically connected to the circuit board, and a wireless transmission module in information connection with the circuit board.

3. The power conversion device with multiple interfaces according to claim 1, wherein the power supply module comprises one of a plug carrying a power cable and a cable-free plug.

4. A power conversion device with multiple interfaces, comprising:
an electronic module, which comprises at least one multiple-in-one connector that comprises a single plugging port and at least one circuit board electrically connected to the multiple-in-one connector; and
a power supply module, which satisfies a standard of an automobile socket and is electrically connected to the circuit board.

5. The power conversion device with multiple interfaces according to claim 4, wherein the electronic module further comprises a battery module electrically connected to the circuit board, a storage module electrically connected to the circuit board, and a wireless transmission module in information connection with the circuit board.

6. The power conversion device with multiple interfaces according to claim 4, wherein the power supply module comprises one of a plug carrying a power cable and a cable-free plug.

7. A power conversion device with multiple interfaces, comprising:
an electronic module, which comprises at least one multiple-in-one connector that comprises a single plugging port and at least one circuit board electrically connected to the multiple-in-one connector; and
a first power supply module, which satisfies a standard of an electric main socket and is electrically connected to the circuit board; and
a second power supply module, which satisfies a standard of an automobile socket and is electrically connected to the circuit board.

8. The power conversion device with multiple interfaces according to claim 7, wherein the electronic module further comprises a battery module electrically connected to the circuit board, a storage module electrically connected to the circuit board, and a wireless transmission module in information connection with the circuit board.

9. The power conversion device with multiple interfaces according to claim 7, wherein the power supply module comprises one of a plug carrying a power cable and a cable-free plug.
